(19) United States
(12) Patent Application Publication
(10) Pub. No.: US 2012/0203457 A1
(43) Pub. Date: Aug. 9, 2012

(54) SYSTEMS AND METHODS FOR VISUALIZING EVENTS TOGETHER WITH POINTS OF INTEREST ON A MAP AND ROUTES THERE BETWEEN

(75) Inventors: Richard P. CASEY, Sunny Isles Beach, FL (US); Sandipsinh G. Ghummad, Edison, NJ (US)

(73) Assignee: The Casey Group, Parsippany, NJ (US)

(21) Appl. No.: 13/366,964

(22) Filed: Feb. 6, 2012

Related U.S. Application Data
(60) Provisional application No. 61/439,584, filed on Feb. 4, 2011.

(51) Int. Cl. G01C 21/00; H04W 4/02; G06F 15/16

(52) U.S. Cl. 701/533; 701/400; 709/217; 455/457

(57) ABSTRACT

This disclosure relates to providing systems and methods for visualizing events together with points of interest on a map and routes there between. The disclosure includes a data processing apparatus having a display and a processor, where the processor is configured to run a module stored in memory. The module is configured to obtain event information associated with a plurality of events, to obtain a schedule of the plurality of events, to obtain travel routes between at least two consecutive events of the schedule, and to instruct the display to display the travel routes between the at least two consecutive events of the schedule on a map. The module can be further configured to obtain location information on a plurality of points of interest (POIs), to obtain tag information associated with the plurality of POIs from at least one directory.

### CROSS-REFERENCE TO RELATED APPLICATION

This application claims benefit under 35 U.S.C. §119(e) of U.S. Provisional Patent Application No. 61/439,584, entitled “SYSTEMS AND METHODS FOR VISUALIZING CALENDAR APPOINTMENTS ON MAP,” filed on Feb. 4, 2011, which is expressly hereby incorporated by reference herein in its entirety.

### TECHNICAL FIELD

The disclosed subject matter relates generally to systems and methods for visualizing events together with points of interest on a map and routes there between.

### BACKGROUND

An electronic scheduling assistant, such as a calendar, is an indispensable tool for modern day business. An electronic scheduling assistant can help users to record upcoming appointments, to plan and to prepare for upcoming appointments, and to organize information related to the upcoming appointments, thereby providing a one-stop solution for dealing with appointments.

Popular electronic scheduling assistants, including Apple iCal, available from Apple, Inc. of Cupertino, Calif., Microsoft Office OUTLOOK, available from Microsoft Corporation of Redmond, Wash. and Google Calendar, available from Google Inc. of Mountain View, Calif., often provide an appointment calendar. The appointment calendar can include one or more blocks indicating time slots. Each time slot can be associated with an appointment, indicated by an appointment entry. An appointment entry can include details of the associated appointment. For example, the appointment entry can indicate the appointment's name, the participants, location, duration, purpose, and/or preparation items. Electronic scheduling assistants can populate the appointment entries by receiving appointment entries from users or by automatically extracting relevant information from information sources, such as E-mails, advertisements, or fax.

Electronic scheduling assistants can provide user interfaces to view and browse appointment entries. Some user interfaces present the appointment entries as a timetable, whereas some user interfaces present the appointment entries as a list, often sorted chronologically. These user interfaces are primarily focused on visualizing the time of the scheduled appointments. However, these user interfaces cannot be used to readily visualize the location of the scheduled appointments, which can be as important as the time of the scheduled appointments. Furthermore, existing scheduling assistants do not provide mechanisms to schedule appointments while meeting certain constraints, such as reducing the travel distance and/or the estimated travel time between appointments.

### SUMMARY

Certain embodiments of the disclosed subject matter include a data processing apparatus. The data processing apparatus includes a display, one or more interfaces configured to provide communication with a server, and a processor, in communication with the one or more interfaces. The processor is configured to run a module stored in memory that is configured to obtain event information associated with a plurality of events. The event information can include a start time of one of the plurality of event. The module can also be configured to obtain travel routes between at least two consecutive events, and to instruct the display to display the travel routes between the at least two consecutive events on a map.

Certain embodiments of the disclosed subject matter include a method of receiving event information associated with a plurality of events and obtaining a schedule of the plurality of events. The schedule of the plurality of events is based on the event information associated with the plurality of events. The method further includes obtaining travel routes between at least two consecutive events and displaying the travel routes on a map.

Certain embodiments of the disclosed subject matter include an apparatus having one or more interfaces configured to provide communication with a computing device and a processor in communication with the one or more interfaces. The processor is configured to run a module stored in memory that is configured to receive a schedule request from the computing device, the schedule request including event information associated with a plurality of events, the event information including a start time and an end time for a schedule of the plurality of events. The module is further configured to obtain distance information between at least one pair of the plurality of events, to determine the schedule of the plurality of events based on the distance information and the start time and the end time for the schedule, and to provide a schedule response to the computing device, the schedule response including the schedule of the plurality of events.

Certain embodiments of the disclosed subject matter include a data processing apparatus. The data processing apparatus includes a display and a processor configured to run a module stored in memory. The module is configured to obtain location information of a first point of interest (POI), to obtain tag information associated with the first POI from a directory, and to instruct the display to display the first POI on a map. The module is further configured to instruct the display to display a portion of the tag information associated with the first POI, where the portion of the tag information is determined based on the directory.

### BRIEF DESCRIPTION OF THE DRAWINGS

FIGS. 1A-1D illustrate a calendar visualization app in accordance with some embodiments of the disclosed subject matter.

FIG. 2 illustrates a server/client architecture for providing a calendar visualization app in accordance with some embodiments of the disclosed subject matter.

FIGS. 3A-3B illustrate a distance matrix and a distance/time matrix provided by a map server in accordance with some embodiments of the disclosed subject matter.

FIGS. 4A-4B illustrate a calendar visualization app for visualizing a travel route based on the estimated travel time in accordance with some embodiments of the disclosed subject matter.

FIG. 5 illustrates a user interface for a calendar visualization app in accordance with some embodiments of the disclosed subject matter.

FIG. 6 illustrates pseudo code for automatically scheduling appointments in accordance with some embodiments of the disclosed subject matter.

FIGS. 7A-7C illustrate an example of automatically scheduling appointments in accordance with some embodiments of the disclosed subject matter.

FIGS. 8A-8C illustrate a calendar visualization app that offers user selectable/customizable pins to identify groups of interest in accordance with some embodiments of the disclosed subject matter.

FIGS. 9A-9B illustrate a calendar visualization app that offers the ability to simultaneously access multiple directories in accordance with some embodiments of the disclosed subject matter.

FIG. 10 illustrates a calendar visualization app that provides for automatic grouping of contacts based on a set of user definable rules in accordance with some embodiments of the disclosed subject matter.

FIGS. 11A-11D illustrate a calendar visualization app that provides for a “look forward” scheduling feature in accordance with some embodiments of the disclosed subject matter.

FIGS. 12A-12B illustrate a calendar visualization app that is capable of accessing multiple calendars in accordance with some embodiments of the disclosed subject matter.

FIG. 13 illustrates a calendar visualization app that alerts the user for upcoming appointments in accordance with some embodiments of the disclosed subject matter.

FIG. 14 illustrates a logical diagram of a computing device in accordance with some embodiments of the disclosed subject matter.

### DETAILED DESCRIPTION

In the following description, specific details are set forth regarding systems and methods of the disclosed subject matter and the environment in which the systems and methods may operate, etc., in order to provide a thorough understanding of the disclosed subject matter. It will be apparent, however, to one skilled in the art that the disclosed subject matter may be practiced without such specific details. In other instances, well-known components, structures, and techniques have not been shown in detail to avoid unnecessarily obscuring the subject matter.

The present disclosure describes systems and methods for visualizing calendar appointments on a map. In some embodiments of the disclosed subject matter, the present disclosure provides systems and methods for visualizing calendar appointments on a map as a route. Additionally, the present disclosure provides systems and methods for scheduling appointments while satisfying constraints, such as reducing the travel distance and/or the estimated travel time between appointments. An appointment is a type of an event. While some of the embodiments of the disclosed subject matter use organizing and scheduling appointments as an example, these embodiments can also organize and schedule other types of events, including, for example, points of interest in an itinerary.

In accordance with an embodiment of the disclosed subject matter, a software application (“application” or “app”) for visualizing calendar appointments is stored on a computing device such as a personal digital assistant, smart phone, tablet computer, or personal computer, etc. For example, the calendar visualization app may be stored on an iPad, which is available from Apple, Inc. of Cupertino, Calif. Other applications can also be stored on the device such as a calendar app and a contacts app. A calendar app can include iCal, which is available from Apple, Inc. of Cupertino, Calif., and a contacts app can include the Contacts in iPhoneOS, which is available from Apple, Inc. of Cupertino, Calif. The contacts app can include name and contact information of people or organizations. The contact information can include a telephone number, an address, or an affiliation. Alternatively, as would be understood by one of skill in the art, the functionality of the calendar visualization app and other apps may be combined in one or more apps. In a further alternative, some or all of the functionality of the calendar visualization app and the other apps may be accessed through a web browser, with or without locally stored apps. Other various are available as would be understood by one of skill in the art.

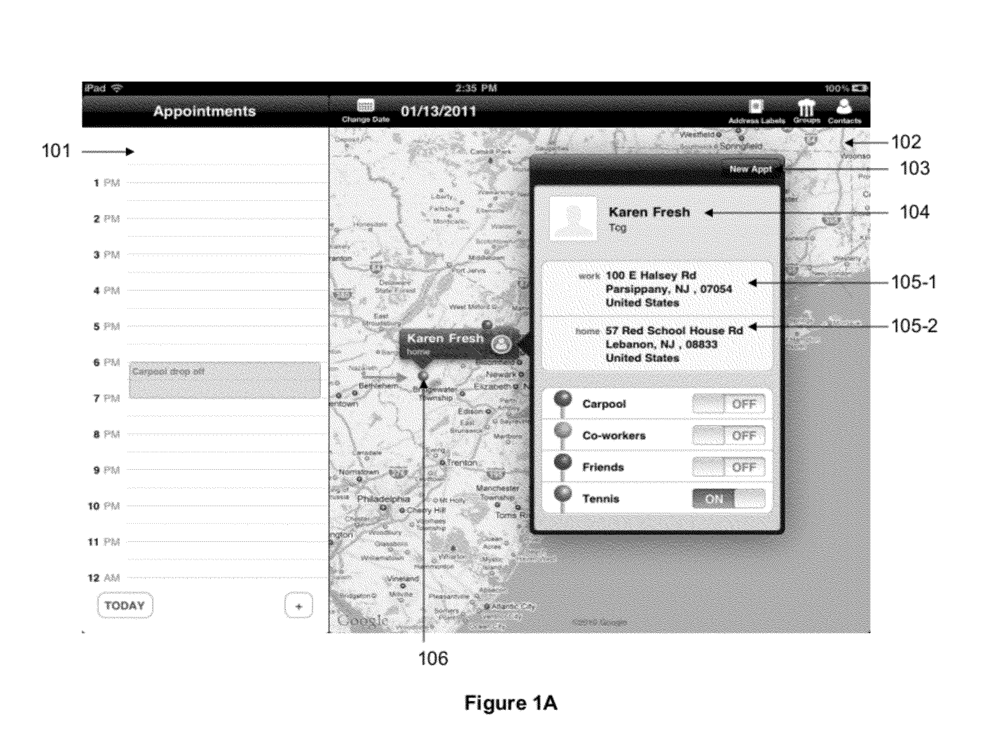

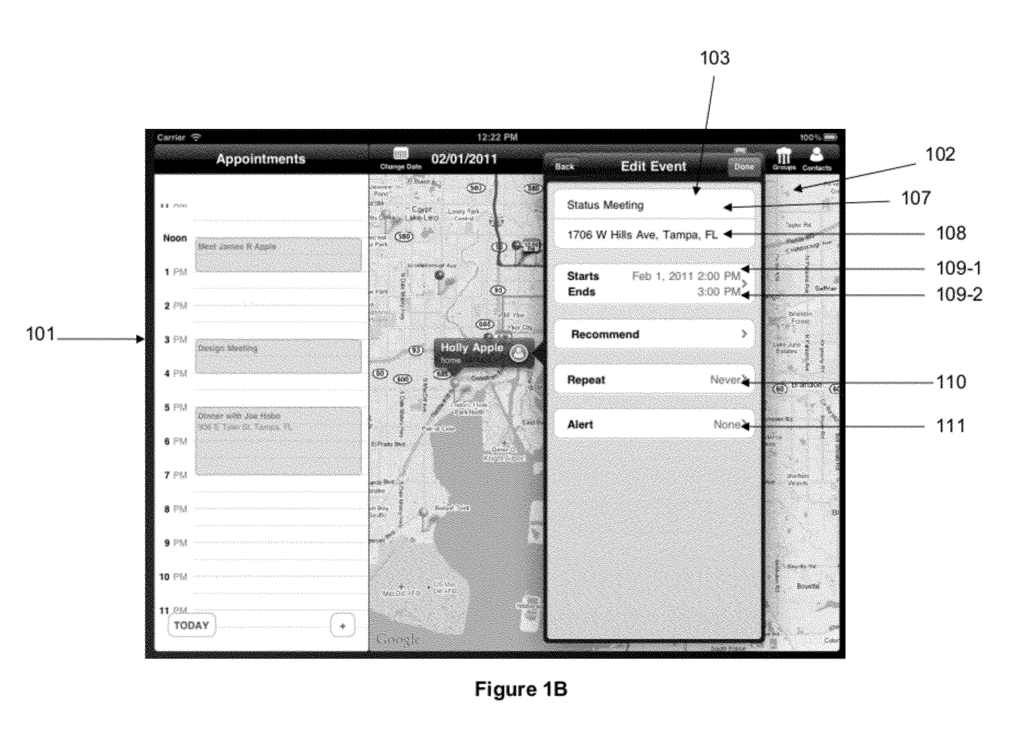

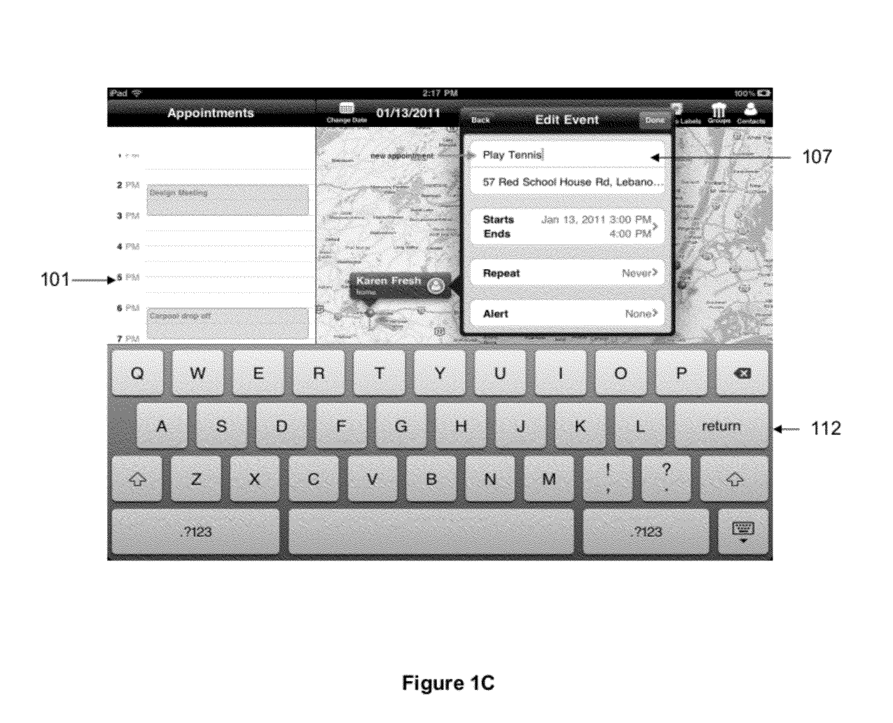

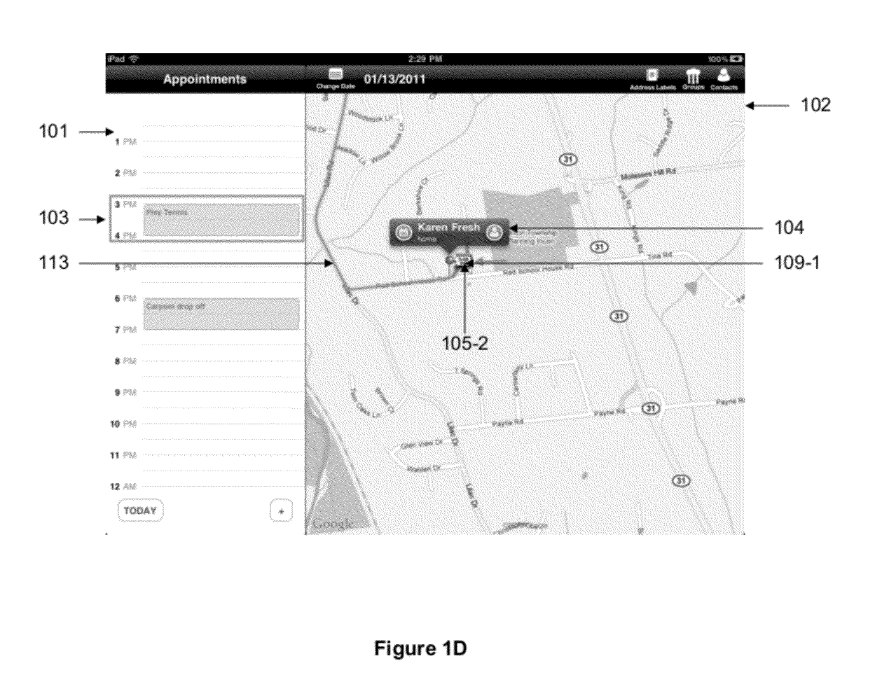

In accordance with some embodiments of the disclosed subject matter, a calendar visualization app can plot and identify appointments on a map. FIGS. 1A through 1D illustrate a calendar visualization app in accordance with some embodiments of the disclosed subject matter. FIG. 1A shows a user interface of the calendar visualization app. The user interface includes an appointment list 101 and a map 102. The map 102 can, for example, be provided by Google Maps or Bing Maps. A new appointment entry 103 can be created with a contact 104 with addresses 105-1 and 105-2. The address 105-2 can for example be displayed as a pin 106 on the map 102. The location of other contacts and other appointments can also be displayed on the map. A location of the contact can be referred to as a point of interest (POI).

FIG. 1B shows that an appointment entry 103 can include appointment details in accordance with some embodiments of the disclosed subject matter. Appointment details can include a name of a contact 107, the contact's location identifier 108, the start and end time of a meeting 109-1, 109-2, repeat frequency of the meeting 110, and alert preferences 111. The location identifier 108 can be a global positioning system (GPS) coordinate, a latitude/longitude coordinate of the Earth, or an address. FIG. 1C shows that the name 107 and/or the appointment details can be entered with a keyboard 112 in accordance with some embodiments of the disclosed subject matter. In certain embodiments, the keyboard 112 can include a physical QWERTY keyboard. In other embodiments, the keyboard 112 can be provided on a touch screen display, and can be temporarily displayed over a portion of the appointment list 101 and the map 102.

FIG. 1D shows that the new appointment entry 103 can be added to the appointment list 101 in accordance with some embodiments of the disclosed subject matter. The calendar visualization app can plot and identify an appointment entry 103 on the map 102. The map 102 can, among other things, display a route 113, an address 105-2, and a start time 109-1 for the appointment entry 103 associated with a contact 104. The calendar visualization app can dynamically determine the user's current location and update the routes based on the current location. The calendar visualization app can receive the user's current location from a network provider. The calendar visualization app can also receive the user's current location from a location determination module of the computing device running the calendar visualization app. For example, the location determination module can include a Global Positioning System (GPS) sensor or other location determining devices.

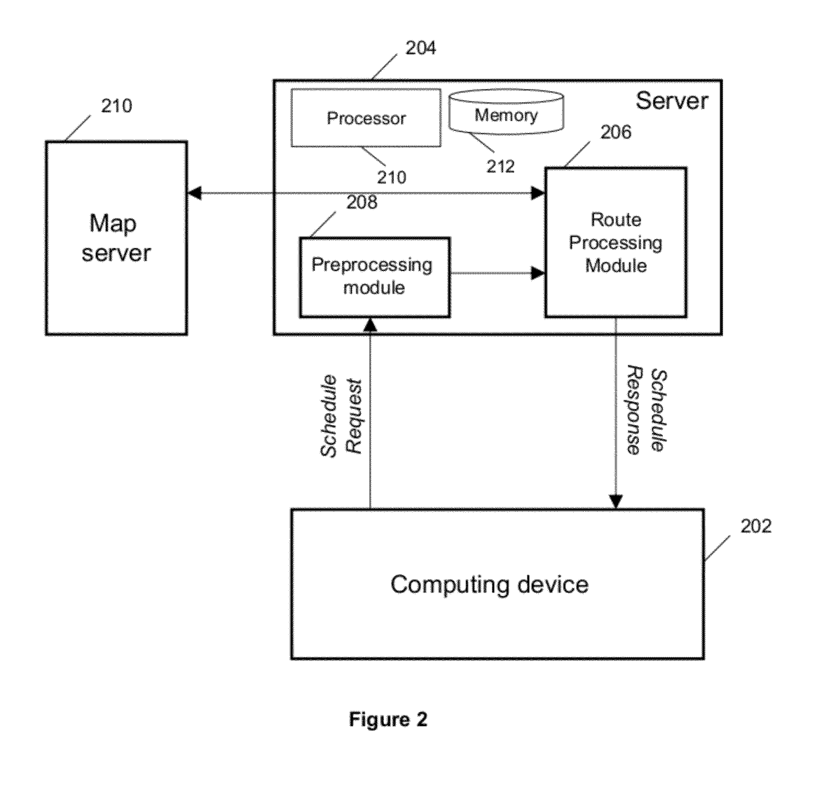

In accordance with some embodiments of the disclosed subject matter, a calendar visualization app can be enabled in a server/client architecture. This server/client architecture can allow a division of labor between a server and a client, which can reduce the amount of computation performed by the client running the calendar visualization app. FIG. 2 illustrates the server/client architecture for the calendar visualization app in accordance with this embodiment. FIG. 2 includes a computing device 202 that can run the calendar visualization app, a server 204 that can process appointment information from the computing device 202 and provide scheduled appointment to the computing device 202, and a map server 210 that can provide map information and route information. The computing device 202 can be configured to communicate with the server 204 over a wireless network, such as, including but not limited to, Wireless LAN, Universal Mobile Telecommunications System (UMTS), High Speed Packet Access (HSPA), HSPA+, or Long Term Evolution (LTE), or over a wired network. The map server 210 can provide map services such as Google Map or Bing Maps.

The server 204 can include a processor 210, memory 212, interfaces, a route processing module 206 that can determine a schedule of appointments (e.g. determine a starting time and an ending time of appointments) and determine travel routes between appointments, and a preprocessing module 208 that can preprocess information from the computing device 202.

A route processing module 206 can determine the travel routes between appointments. If all the appointments are fixed to a certain time slot, the route processing module 206 can provide the travel routes to travel from one appointment to the next appointment. If some of the appointments are flexible and can occur in one or more time slots, the route processing module 206 can schedule such movable appointments to satisfy user-specified constraints. The user-specified constraints can include reducing the travel time between appointments, reducing the travel distance between appointments, or reducing both the travel time and the travel distance between appointments. The route processing module 206 can cooperate with a map server to determine travel routes. A map server can provide map services, such as Google Map or Bing Map. The route processing module 206 can also use a scheduling algorithm to determine the schedule of movable appointments. The scheduling algorithm can include an ant colony optimization algorithm.

A preprocessing module 208 can receive data from the computing device 202 and preprocess the received data so that the data can be easily manipulated by the route processing module 206.

The route processing module 206 and the preprocessing module 208 can be implemented in software, which is stored in memory 212. The memory 212 includes a computer readable medium, a programmable read only memory (PROM), or flash memory. The software runs on a processor 210 capable of executing computer instructions or computer code. These modules might also be implemented in hardware using an application specific integrated circuit (ASIC), programmable logic array (PLA), field programmable gate array (FPGA), or any other integrated circuit.

An interface provides an input and/or output mechanism to communicate over a network. The interface enables communication with computing devices 202, as well as other core network nodes to send and receive data. The interface is implemented in hardware to send and receive signals in a variety of mediums, such as optical, copper, and wireless, and in a number of different protocols some of which may be non-transient.

The server 204 operates using an operating system (OS) software. In some embodiments, the OS software is based on a Linux software kernel and runs specific applications in the server such as monitoring tasks and providing protocol stacks. The OS software allows server resources to be allocated separately for control and data paths. For example, certain packet accelerator cards and packet services cards are dedicated to performing routing or security control functions, while other packet accelerator cards/packet services cards are dedicated to processing user session traffic. As network requirements change, hardware resources are dynamically deployed to meet the requirements in some embodiments.

The server's software is divided into a series of tasks that perform specific functions. These tasks communicate with each other as needed to share control and data information throughout the server 204. A task is a software process that performs a specific function related to system control or session processing. Three types of tasks operate within the server 204 in some embodiments: critical tasks, controller tasks, and manager tasks. The critical tasks control functions that relate to the server's ability to process calls such as server initialization, error detection, and recovery tasks. The controller tasks mask the distributed nature of the software from the user and perform tasks such as monitor the state of subordinate manager(s), provide for intra-manager communication within the same subsystem, and enable inter-subsystem communication by communicating with controller(s) belonging to other subsystems. The manager tasks can control system resources and maintain logical mappings between system resources.

Individual tasks that run on processors in the application cards are divided into subsystems. A subsystem is a software element that either performs a specific task or is a culmination of multiple other tasks. A single subsystem includes critical tasks, controller tasks, and manager tasks. Some of the subsystems that run on the server 204 include a system initiation task subsystem, a high availability task subsystem, a shared configuration task subsystem, and a resource management subsystem.

The system initiation task subsystem is responsible for starting a set of initial tasks at system startup and providing individual tasks as needed. The high availability task subsystem works in conjunction with the recovery control task subsystem to maintain the operational state of the server 204 by monitoring the various software and hardware components of the server 204. Recovery control task subsystem is responsible for executing a recovery action for failures that occur in the server 204 and receives recovery actions from the high availability task subsystem. Processing tasks are distributed into multiple instances running in parallel so if an unrecoverable software fault occurs, the entire processing capabilities for that task are not lost. User session processes can be sub-grouped into collections of sessions so that if a problem is encountered in one sub-group users in another sub-group will not be affected by that problem.

Shared configuration task subsystem provides the server 204 with an ability to set, retrieve, and receive notification of server 204 configuration parameter changes and is responsible for storing configuration data for the applications running within the server 204. A resource management subsystem is responsible for assigning resources (e.g., processor and memory capabilities) to tasks and for monitoring the task's use of the resources.

In some embodiments of the disclosed subject matter, the server 204 resides in a data center and forms a node in a cloud computing infrastructure. The server 204 provides services on demand. A module hosting a client is capable of migrating from one server to another server seamlessly, without causing any program faults or system breakdown.

A user can use the server/client architecture to schedule appointments in accordance with some embodiments. To schedule appointments, a user can provide appointment details associated with one or more appointments to the computing device 202. Appointment details can include one or more of the following: the starting time of the appointment, the duration of the appointment, and/or the POI of the associated appointment. Once the computing device 202 receives the appointment details, the computing device 202 can send, to the server 204, a schedule request including the appointment details.

When the server 204 receives the schedule request, the server 204 can direct the schedule request to the pre-processing module 208. The pre-processing module 208 can preprocess the information in the schedule request so that the received information can be readily processed by the route processing module 206. Once preprocessed, the preprocessing module 208 can send the schedule request to the route processing module 206. Subsequently, the route processing module 206 can use the information in the schedule request to determine appointment schedules and travel routes between consecutive appointments.

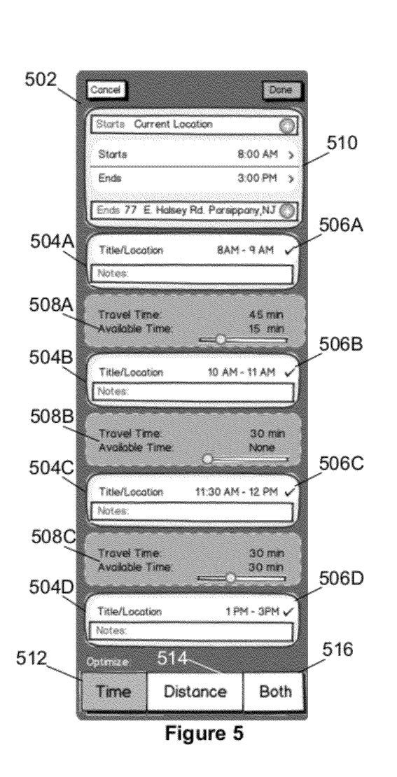

In some embodiments of the disclosed subject matter, the user can specify the start time of all appointments, in which case the route processing module 206 can only determine the travel routes between consecutive appointments. If the start time of one or more appointments is not provided, the route processing module 206 can schedule the appointments according to user-specified constraints or preferences. These embodiments are further described in connection to FIGS. 5-7.

The route processing module 206 can cooperate with a map server 210 to determine the routes between user-specified appointments. For example, the route processing module 206 can send location information associated with the appointments to the map server 210. The location information can be represented, for example, using GPS coordinates, or using the latitude/longitude of the Earth or the standard address. The map server 210 can process the received location information to determine the travel information between every pair of appointments. The travel information between every pair of appointments can include one or more of the following: the routes between every pair of appointments, the distance between every pair of appointments, and the estimated travel time between every pair of appointments.

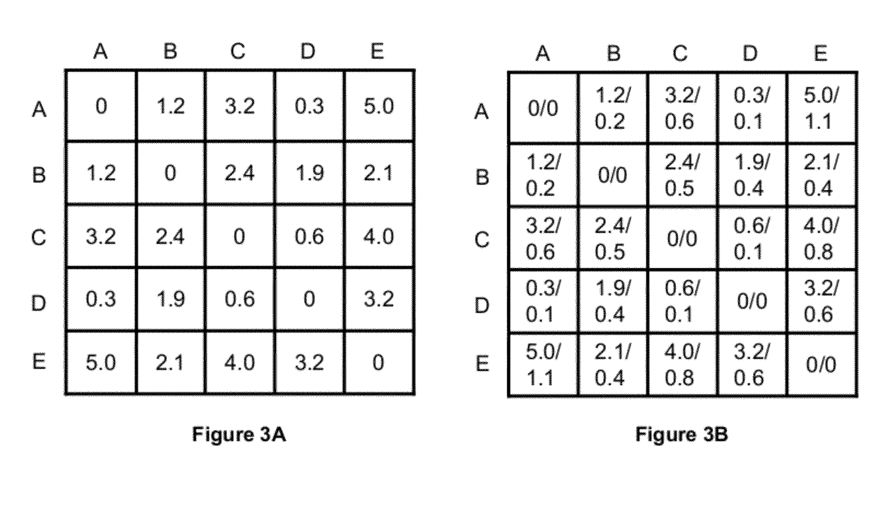

In some embodiments of the disclosed subject matter, the map server 210 can represent the distance between every pair of appointments as a distance matrix. FIG. 3A illustrates a distance matrix in accordance with certain embodiments of the disclosed subject matter. In particular, FIG. 3A illustrates a scenario in which the user provided 5 appointments, A-E to the computing device 202, which forwarded the appointment information to the server 206. Each entry in the distance matrix indicates the distance between two appointments identified by the row and column. For example, the third column in the first row indicates the distance between two POIs, A and C. The estimated travel time between every pair of appointments can be represented as a time matrix. As with the distance matrix, each entry in the time matrix indicates the travel time between two appointments identified by the row and column. In one embodiment, the distance matrix and the time matrix can be merged into a single distance/time matrix, as illustrated in FIG. 3B. The first entry of each cell indicates the distance and the second entry of each cell indicates the estimated travel time.

Once the map server 210 determines the travel information, the map server 210 can provide the travel information to the route processing module 206. The route processing module 206 can use the travel information to determine the route, distance and/or estimated travel time between consecutive appointments and provide this information to the computing device 202 in a schedule response.

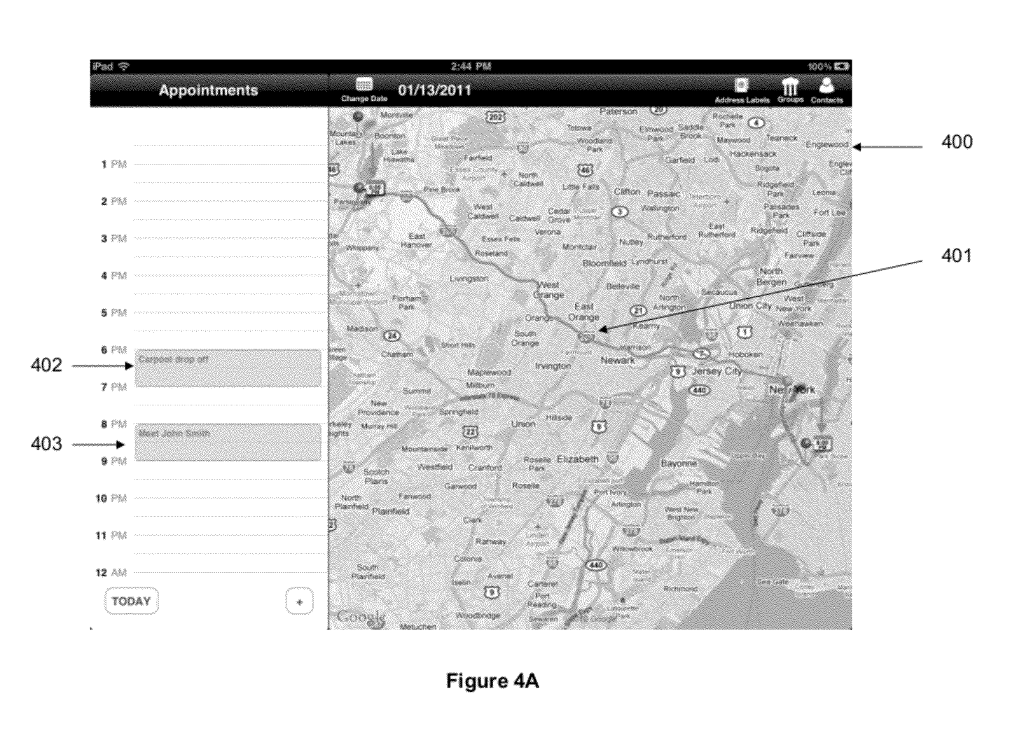

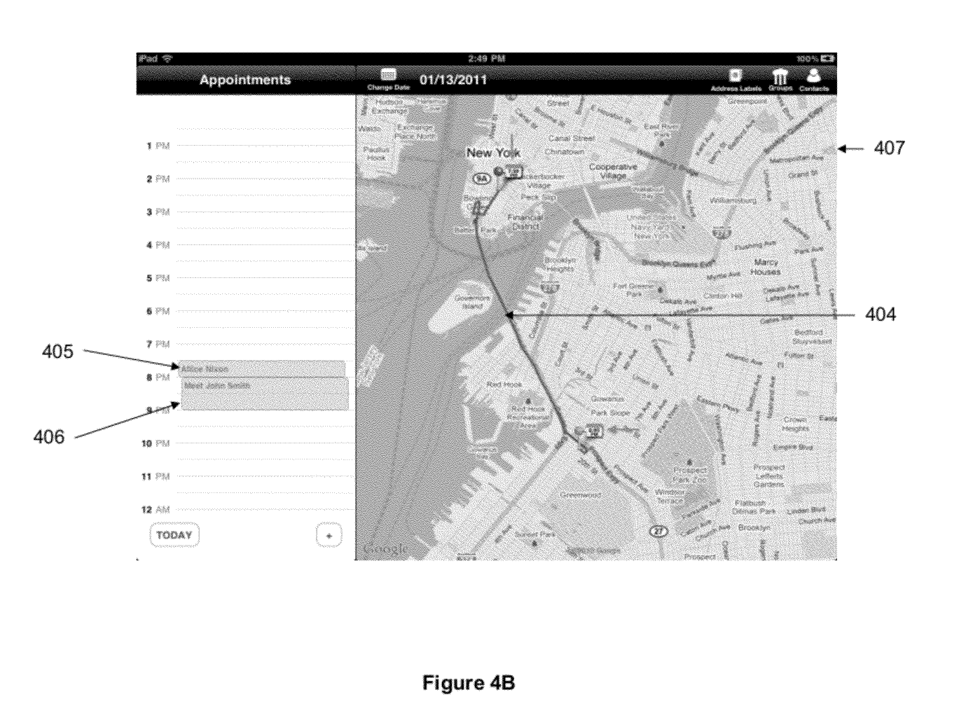

In accordance with some embodiments of the disclosed subject matter, a calendar visualization app can provide color coded routes based on the estimated travel time between appointments. In these embodiments, if the time between two consecutive appointments is greater than the estimated travel time, the route between the two events is colored with a first color. If not, the route between the two events is colored with a second color. The first color can include, e.g., green, and the second color can include, e.g., red. Alternatively, a different combination of colors can be used. FIGS. 4A and 4B show a calendar visualization app in accordance with these embodiments of the disclosed subject matter. FIG. 4A shows a map 400 with a route 401 in green because the time between the two appointments 402 and 403 is greater than the estimated travel time between the two appointments 402 and 403. In contrast, FIG. 4B shows a map 407 with a route 404 in red because the time between appointments 405 and 406 is less than the estimated travel time.

In accordance with some embodiments of the disclosed subject matter, a calendar visualization app provides for scheduling of movable appointments. Movable appointments can include appointments that can be scheduled for one of many candidate time slots. A user interface 502 in FIG. 5 shows a calendar visualization app in accordance with these embodiments.

The user interface 502 includes a route parameter selection pane 510 that indicates the route selection parameters for the day's schedule. The route selection parameters can include one or more of the following: the starting position of the schedule, the ending position of the schedule, the starting time of the schedule, and the ending time of the schedule. The user can specify one or more of the route selection parameters by selecting desired values on the parameter selection pane 510.

The user interface 502 also includes one or more appointment entries 504A-504D. Appointment entries 504A-504D have status indicators 506A-506D that indicate whether the associated appointments are movable or not. A user can toggle the status indicators 506A-506D to indicate whether the associated appointments are movable or not.

The user interface 502 further includes floating time entries. The floating time entries can indicate the travel time between two consecutive appointments and the available time (e.g., free time) between two consecutive events. When one of the two consecutive appointments is movable, then user can modify the available time field 508 to modify the free time between two appointments. By adjusting the available time, the user can modify the start time(s) of succeeding appointment(s). For example, increasing the available time 508 can delay the start time of succeeding appointment(s), whereas reducing the available time 508 can advance the start time of succeeding appointment(s). In some embodiments of the disclosed subject matter, the calendar app automatically sets the available time to zero or to a predetermined value when a user double-clicks on the available time field 508.

The available time between two moveable appointments can range from zero to a fixed value. This fixed value can be determined by summing all the available times of succeeding, contiguous movable appointment(s). In other words, a non-movable appointment can act as a delimiter for the summation process. For example, in FIG. 5, the maximum available time prior to the second appointment 504B is 45 minutes (the sum of 508A, 508B, and 508C). Therefore, as the user varies the available time from 0 to 45 minutes, the start time of the second appointment can automatically be modified from 9:45 AM to 10:30 AM. Therefore, by setting the available time to 45 minutes, it would have the effect of changing the start time of the second appointment to 10:30 AM and the start time of the third appointment to 12 PM, modifying two appointments (the second and third appointments) simultaneously. Therefore, this embodiment of the disclosed subject matter can provide simple mechanisms to schedule moveable appointments.

In accordance with some embodiments of the disclosed subject matter, a calendar visualization app provides for an automatic scheduling of movable appointments. Because movable appointments can be allotted to one of many time slots, movable appointments provide flexibility to appointment scheduling. The calendar app can leverage such flexibility to satisfy certain constraints. These constraints can include, for example, reducing the travel time between appointments and/or reducing the travel distance between appointments. A user can select the constraints using, for example, the interface of FIG. 5. When a user selects the time button 512, the calendar app can schedule the appointments while reducing the travel time between appointments; when the user selects the distance button 514, the calendar app can schedule the appointments while reducing the travel distance between appointments; and when the user selects the “both” button 516, the calendar app can schedule the appointments while reducing both the travel time and the travel distance between appointments.

As discussed above, a user can use the user interface of FIG. 5 to indicate which appointments are movable. The user can also specify characteristics of travel routes. The characteristics can include, for example, a shorter travel distance or a shorter estimated travel time, or both. Furthermore, the user can specify one or more of route selection parameters using, for example, the route parameter selection pane 510.

If the starting point and ending point of the day's schedule are coincidental, the appointments can be scheduled as a round trip. Also, if the starting time and the ending time are both specified, the appointment can be scheduled as a “Time Boxed” schedule. In some cases, the starting time and the ending time can be specified such that the amount of time between the starting time and the ending time is less than the total duration of appointments. To address these cases, users can additionally specify certain appointments as required, indicating that the associated appointments need to occur within a specified time window.

In some embodiments of the disclosed subject matter, the automatic scheduling of movable appointments can be performed at the route processing module 206 of the server 204 in FIG. 2. In some embodiments of the disclosed subject matter, the route processing module 206 can model the scheduling of movable appointments as a traveling salesman problem (TSP) and solve this problem using a variant of an ant colony optimization algorithm. At a high level, the route processing module 206 schedules the movable appointments in an iterative manner. The route processing module 206 can first estimate a rough solution to the appointment scheduling. Then the route processing module 206 can use the estimated rough solution to update parameters of the scheduling problem. Subsequently, the route processing module 206 can use the updated parameters to re-estimate the rough solution to the scheduling problem and iterate this process until the solution converges.

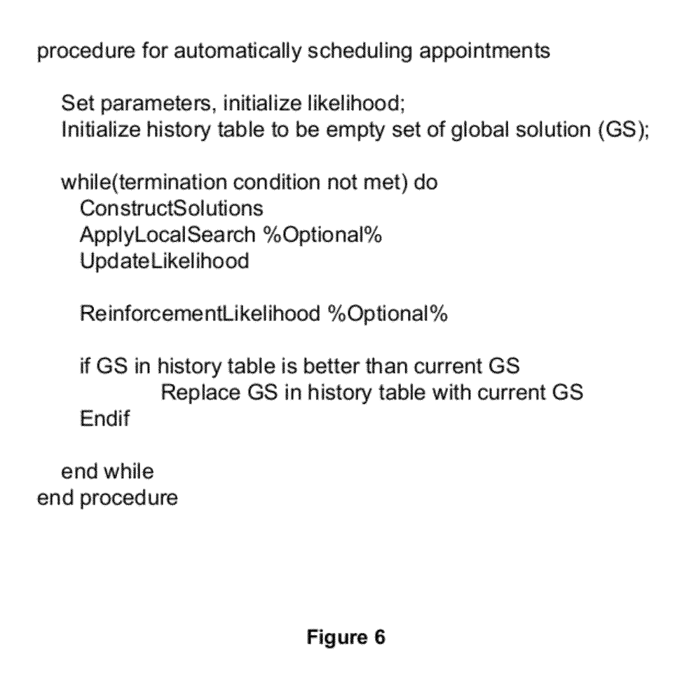

FIG. 6 illustrates a pseudocode of the automatic scheduling method in accordance with some embodiments of the disclosed subject matter. The automatic scheduling method can find an ordering of appointments (e.g., a schedule of appointments) that has a high aggregate probability. The aggregate probability includes a product of transition probabilities between every consecutive appointment. In some embodiments of the disclosed subject matter, the automatic scheduling method can find the ordering of appointments with a high aggregate probability in an iterative manner. In each iteration, the automatic scheduling method maintains the best solution found thus far in a history table.

The automatic scheduling method first initializes parameters. The parameters can include a likelihood parameter indicating how likely it is for two appointments to be consecutive. The automatic scheduling method also initializes the history table to an empty set.

Subsequently, the automatic scheduling method performs the ConstructSolutions step. The ConstructSolutions step estimates a set of solutions to the scheduling problem. A solution to the scheduling problem is an ordering of appointments (or a schedule of appointments) that has a high aggregate probability. As discussed above, the aggregate probability includes the product of transition probabilities between every consecutive appointment in the ordering of appointments.

The transition probability, the probability of an appointment i being followed by an appointment j, at the t^{th} iteration of the method is computed as follows:

p^{k}ᵢⱼ=τᵢⱼ(t)×[ηᵢⱼ]^{β}

where ηᵢⱼ represents the heuristic information and τᵢⱼ represents the likelihood information. The location of appointments i and j can also be referred to as points of interest (POI) in the context of TSP. β, which can have a value between 0 and 1, can control the influence of the heuristic information ηᵢⱼ in estimating the solution.

The likelihood information τᵢⱼ can represent the likelihood of an appointment i being followed by an appointment j. τᵢⱼ can be updated after each iteration of the scheduling method. The likelihood information τᵢⱼ can be updated based on the solution estimated from previous iterations, as detailed in the UpdateLikelihood step. The likelihood information τᵢⱼ can be organized in a matrix form, called a likelihood matrix.

The heuristic information ηᵢⱼ can depend on the user-specified constraints. For example, if a user wants to reduce the travel distance between appointments, then the heuristic information ηᵢⱼ can be defined as:

$${η}_{ij} = \frac{1}{{d}_{ij}} ,$$

where dᵢⱼ is the distance between the POIs i and j.
If the user wants to reduce the estimated travel time between appointments, then the heuristic information ηᵢⱼ can be defined as:

$${η}_{ij} = \frac{1}{{t}_{ij}} ,$$

where tᵢⱼ is the estimated travel time to travel from appointment i to appointment j. If the user wants to reduce both the distance and the estimated travel time between appointments, then the heuristic information ηᵢⱼ can be defined as:

$${η}_{ij} = \frac{1}{{d}_{ij}} \times \frac{1}{{t}_{ij}} .$$

dᵢⱼ and tᵢⱼ can be provided by the map server 210, as illustrated with respect to FIG. 2.

In certain embodiments, the transition probability can take into account additional constraints from the user. These additional constraints can be incorporated into the heuristic information ηᵢⱼ to steer the solution to satisfy the additional constraints.

In case a user specifies that the desired schedule is time-boxed (e.g., the starting time and the ending time of the schedule are predetermined) and round-trip (e.g., the starting location of the schedule coincides with the ending location of the schedule), then the route processing module 206 can take into account the time it takes to travel from the last appointment back to the starting position. If the sum of (a) the estimated round-trip travel time between the starting location and a particular appointment and (b) the duration of the particular appointment exceeds the amount of time between the starting time and the ending time of the schedule, then there is not a schedule that can accommodate the particular appointment while satisfying the starting time and the ending time of the schedule. In this case, the route processing module 206 indicates this issue and can discard this particular appointment from the schedule.

In certain embodiments, the user can indicate preferred appointments. Preferred appointments are appointments the user would like to include in the generated schedule. The route processing module 206 can take into account the preferred appointments by modifying the heuristic information ηᵢⱼ associated with the preferred appointments. In one embodiment, the heuristic information can be updated to η′ᵢⱼ, as follows:

η′ᵢⱼ=ηᵢⱼ+ωηᵢⱼ

where the weight ω can range from −1 to 1. The sign of the weight ω can depend on the user-specified constraints. For example, if the user wants to reduce certain travel parameters, such as the travel time or the travel distance, then the sign of the weight can be negative. On the other hand, if the user wants to increase certain travel parameters, then the sign of the weight can be positive.

In certain embodiments, the route processing module 206 can use the ApplyLocalSearch step to reduce the chance of settling at a local solution. The ApplyLocalSearch step can include a 2-Cut method. The 2-Cut method is disclosed in “An efficient heuristic procedure for partitioning graphs” by Kernighan and Lin, published in 1970, in Bell System Technical Journal, which is herein incorporate by reference in its entirety.

The UpdateLikelihood step can include two steps: the global likelihood update and the local likelihood update. The global likelihood update includes updating the likelihood information τᵢⱼ based on the solution with the highest aggregate probability among the set of solutions found in the ConstructSolutions step (and optionally the ApplyLocalSearch step) of this iteration t, also called the current global solution. The likelihood information τᵢⱼ can be updated as follows:

τᵢⱼ(t+1)=(1−ρ)×τᵢⱼ(t)+ρ×Δτ^{gb}ᵢⱼ(t)

where 0<ρ<1 is a decay parameter, indicating how much to rely on the previous likelihood information τᵢⱼ and the likelihood step Δτ^{gb}ᵢⱼ(t) indicates the likelihood value to be added to the previous likelihood information τᵢⱼ of iteration t. The likelihood step Δτ^{gb}ᵢⱼ(t) can depend on user-specified constraints. For example, if the user wants to reduce the travel distance between appointments, then the likelihood step Δτ^{gb} (t) can be defined as:

$${Δτ}_{ij}^{gb} ( t ) = \frac{1}{{L}^{gb}} ,$$

where L^{gb} is the total travel distance of the schedule.
If the user wants to reduce the estimated travel time between appointments, then the likelihood step Δτ^{gb}ᵢⱼ(t) can be defined as:

$${Δτ}_{ij}^{gb} ( t ) = \frac{1}{{T}^{gb}} ,$$

where T^{gb} is the total estimated travel time of the schedule.
If the user wants to reduce both the distance and the estimated travel time between appointments, then the likelihood step Δτ^{gb}ᵢⱼ(t) can be defined as:

$${Δτ}_{ij}^{gb} ( t ) = \frac{1}{{L}^{gb}} \frac{1}{{T}^{gb}} .$$

If the schedule is time-boxed, then the likelihood step Δτ^{gb}ᵢⱼ(t) can be defined as:

Δ̅τ̅^̅{̅g̅b̅}̅ᵢ̅ⱼ̅(̅t̅)̅=n×Δτ^{gb}ᵢⱼ(t), where n is the number of appointments in the schedule.

In addition to the global likelihood update, the route processing module 206 can perform a local likelihood update. In some embodiments, the local likelihood update includes updating the likelihood information τᵢⱼ as soon as a solution having the consecutive POIs i and j is identified. The likelihood information τᵢⱼ can be updated as follows:

τᵢⱼ=(1+ξ)×τᵢⱼ+ξ×τ_{D}

where 0<ξ<1 and τ_{d} are two parameters that can be predetermined.

In some embodiments, the automatic scheduling algorithm can update the likelihood information τᵢⱼ of two appointments using the ReinforcementLikelihood step. The ReinforcementLikelihood step can compare the current global solution and the solution in the history table. If two appointments consecutive in the current global solution are also consecutive in the solution in the history table, then there is a high probability that these two appointments would be consecutive in the final solution. Therefore, the ReinforcementLikelihood step would increase the likelihood information τᵢⱼ of associated with these two appointments. In one embodiment, the likelihood information τᵢⱼ of associated with those two appointments can be increase as follows:

τᵢⱼ′=τᵢⱼ+C

where C is a predetermined constant. The parameter C can be controlled to control how much to favor reoccurring consecutive appointments.

After the UpdateLikelihood step or the ReinforcementLikelihood step, the current global solution is compared to the solution in a history table. If the current global solution has a higher aggregate probability than the solution in the history table, the solution in the history table is replaced with the current global solution.

These processing steps are iterated until a termination condition is met. A termination condition can include, for example, the number of iteration greater than a predetermined number or the aggregate probability of the solution greater than a predetermined value.

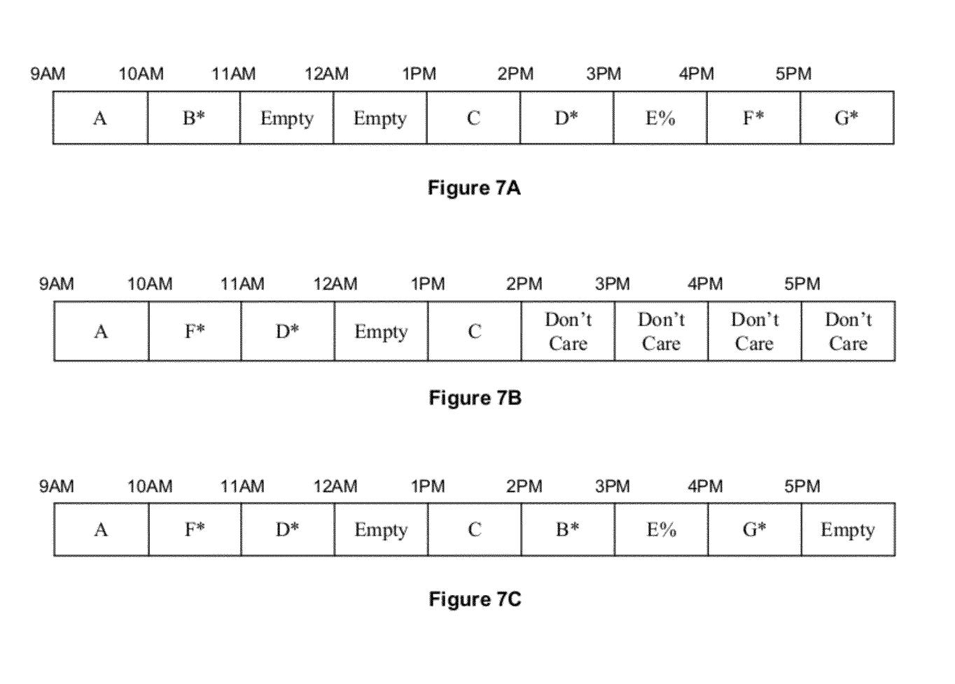

FIG. 7A-7C illustrate an example of the results of using the automatic scheduling method of FIG. 6, in accordance with some embodiments of the disclosed subject matter. In this example, a user indicates that the starting time and the ending time of the schedules are 9 AM and 4 PM, respectively. Therefore, the schedule is time-boxed. FIG. 7A illustrates the available time slots between the user-specified starting time and ending time, where each time slot can accommodate one of the appointments A-G. Appointments with an asterisk indicate movable appointments; appointments with % indicate movable appointments that are required to be included within a specified time period. For example, the appointment E is required to be scheduled between 1 PM-4 PM. Appointments without an asterisk or % indicate fixed appointments with a predetermined starting time. For example, appointments A and C are fixed appointments. In FIG. 7A, the movable appointments are randomly assigned to time slots for illustration.

The route processing module 206 can analyze the user-specified appointment details and can iteratively perform the automatic scheduling method of FIG. 6 to schedule the appointments. As a first step, the route processing module 206 can identify time windows bounded by fixed appointments, starting time and/or the ending time of the schedule. According to FIG. 7A, there are two such time windows: 9 AM-1 PM, bounded by the fixed appointments A and C, and 1 PM and 4 PM, bounded by the time-fixed appointment C and the user defined Ending Time 4 PM. The route processing module 206 can estimate schedules for each of the two time windows independently. In certain embodiments, the route processing module 206 can first fill the first time window and progressively fill later time windows. In other embodiments, the route processing module 206 can first fill the last time window and progressively fill earlier time windows. This example illustrates an embodiment of the disclosed subject matter in which the first time window is scheduled first.

The route processing module 206 can initialize the scheduling of the first time window (e.g., 9 AM-1 PM) based on the appointment details illustrated in FIG. 7A. For example, the route processing module 206 sets the starting location to be the location of appointment A, the ending location to be the location of appointment C, a time-box to be 9 AM-1 PM, and the list of movable appointments to be B, D, F, and G (excluding E due to its time constraints). The route processing module 206 can automatically schedule these movable appointments within the first time window using the method of FIG. 6. One possible outcome of the method is illustrated in FIG. 7B. FIG. 7B shows that the first time window accommodates movable appointments F and D.

Once the route processing module 206 determines the schedule for the first time window, the route processing module 206 can move onto scheduling appointments for the second time window. The route processing module 206 can initialize the scheduling of the second time window (e.g., 1 PM-4 PM) based on the appointment details, illustrated in FIG. 7A, and the completed schedule of the first time window. For example, the route processing module 206 sets the starting location to be the location of appointment C, a time-box to be 1 PM-4 PM, and the list of movable appointments to be B, E, and G. The route processing module 206 can automatically schedule these movable appointments within the second time window using the method of FIG. 6. The method is iterated until the user-specified constraints are satisfied. For example, if the appointment E is not assigned to one of the required time slots, then the route processing module 206 would re-run the scheduling method of FIG. 6 until that constraint is satisfied. One possible outcome of the method is illustrated in FIG. 7C. In this schedule, the appointment G did not fit within the identified time box (9 AM-4 PM), but that appointment was not required to fit within the second time window, therefore, this solution is legitimate.

In some embodiments, the scheduling method of FIGS. 6-7 can be used to identify an itinerary. For example, a user can provide POIs the user would like to visit. The scheduling method of FIGS. 6-7 can use the provided POIs to determine the order of visiting the POIs. The scheduling method can also identify the time at which to visit the POIs, and also the travel routes to visit the POIs.

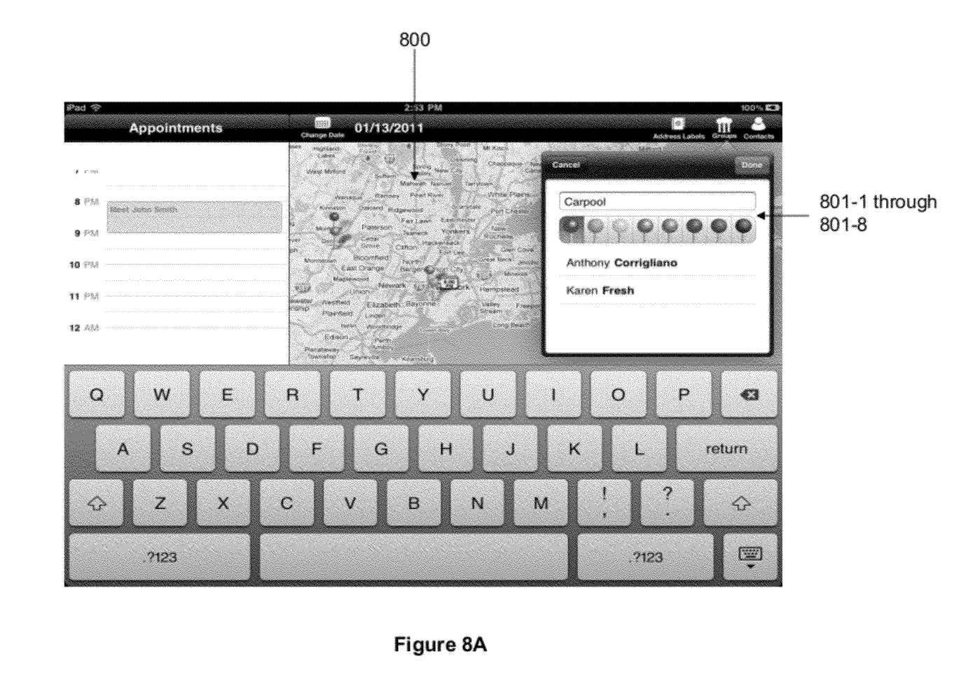

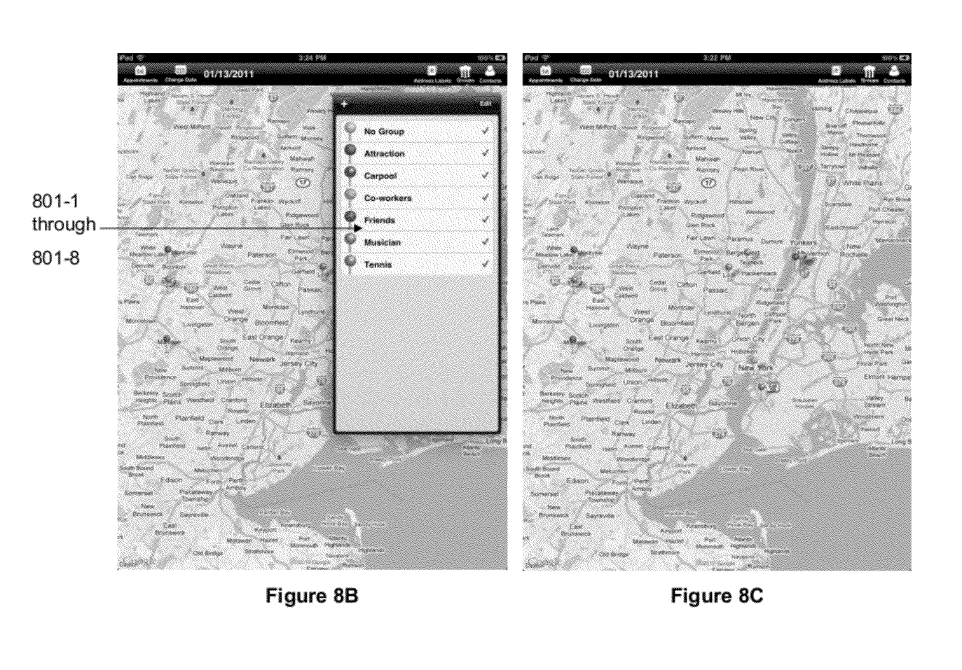

In accordance with some embodiments of the disclosed subject matter, a calendar visualization app provides user selectable/customizable pins to identify groups of interest. FIGS. 8A through 8C show a calendar visualization app in accordance with these embodiments of the disclosed subject matter. Contacts can be divided into groups based on the contact information associated with the appointment, e.g., friends, co-workers, attraction, etc. Different groups can be identified with customized pins. Customized pins include pins of different colors. FIG. 8A shows selectable/customizable pins 801-1 through 801-8. FIG. 8A further shows that selectable/customizable pins 801-1 through 801-8 can be displayed on the map 800.

The calendar visualization app can selectively display groups in accordance with specified user preferences. For example, a user can select a particular group (e.g., Friends), in which case the calendar app displays POIs associated with that particular group on a map. The user can select more than one group, in which case the calendar app displays POIs associated with at least one of the selected groups. In some embodiments, a POI can be associated with only one group. In other embodiments, a POI can be associated with one or more groups. If a POI is associated with more than one group, a user can prompt the app to display POIs satisfying all of user selections. For example, if a user selects groups “Friends” and “Musician”, then the app can display POIs that is associated with both “Friends” and “Musician.”

In some embodiments, the calendar app can display appointments for a selected period of time on a map. For example, a user can specify that the map includes appointments in the next five days.

FIGS. 8B and 8C further illustrate that selectable/customizable pins 801-1 through 801-8 can be displayed on the map.

In accordance with some embodiment of the disclosed subject matter, a calendar visualization app offers the ability to simultaneously access multiple directories for displaying information on a POI. The calendar visualization app can display a POI on a map and display tag information associated with the POI. The tag information can include information about the POI, such as the “park”, “business”, “building”, “subway”, “sea”, “mountain”, “home”, etc. . . . The tag information can also include information on a contact (e.g., person) associated with that POI, including a name, a telephone number, or an affiliation. The tag information can further include a review of the POI, a rating of the POI, pictures, geographic information, or demographic information.

In some embodiments, the tag information can be automatically retrieved from a directory. A directory can include an address book, including a contacts app installed on a computing device, a contacts app available on the network, an electronic Yellow page with contact information. The directory can also include encyclopedia, including Wikipedia and Encarta. The directory can also include social networking sites such as FACEBOOK, LINKEDIN, or YELP. The directory can also include a public/private database of customers/contacts, including a customer relationship management app, including SALESFORCE.COM. The directory can also include a travel guide of destinations. The travel guide includes, for example, a travel guide from American Automobile Association (AAA). The directory can additionally include, for example, a restaurant guide. The restaurant guide can include a guide from Zagat. In one embodiment, when the app displays information associated with a POI, the displayed information can depend on the source of the tag information (e.g., directory). For example, if a POI is retrieved from a travel guide, then the app can display pictures and descriptive information about the POI. In some embodiments, a user can select one of the POIs to create or update appointments at the POI.

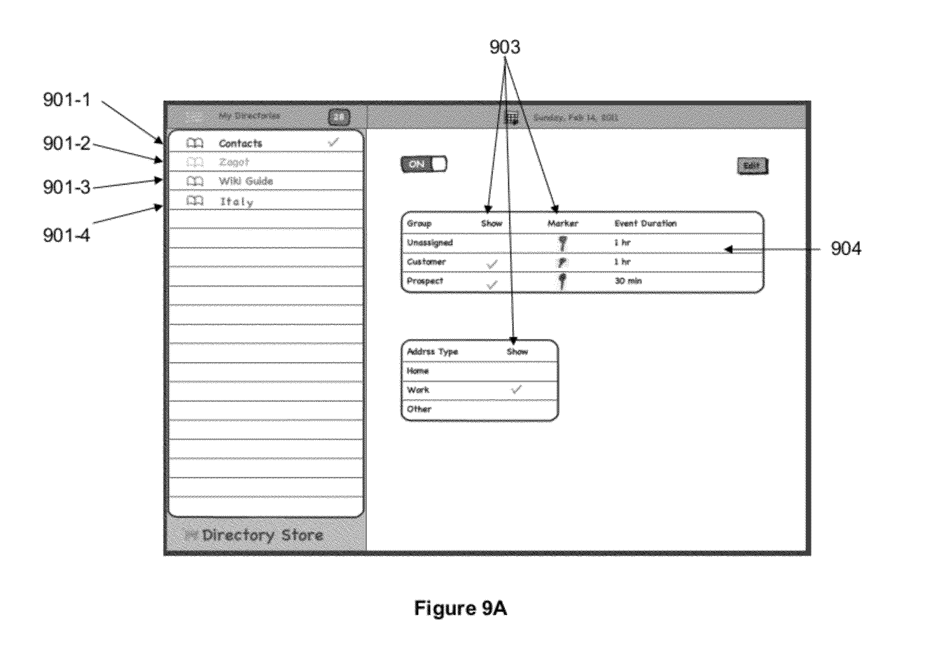

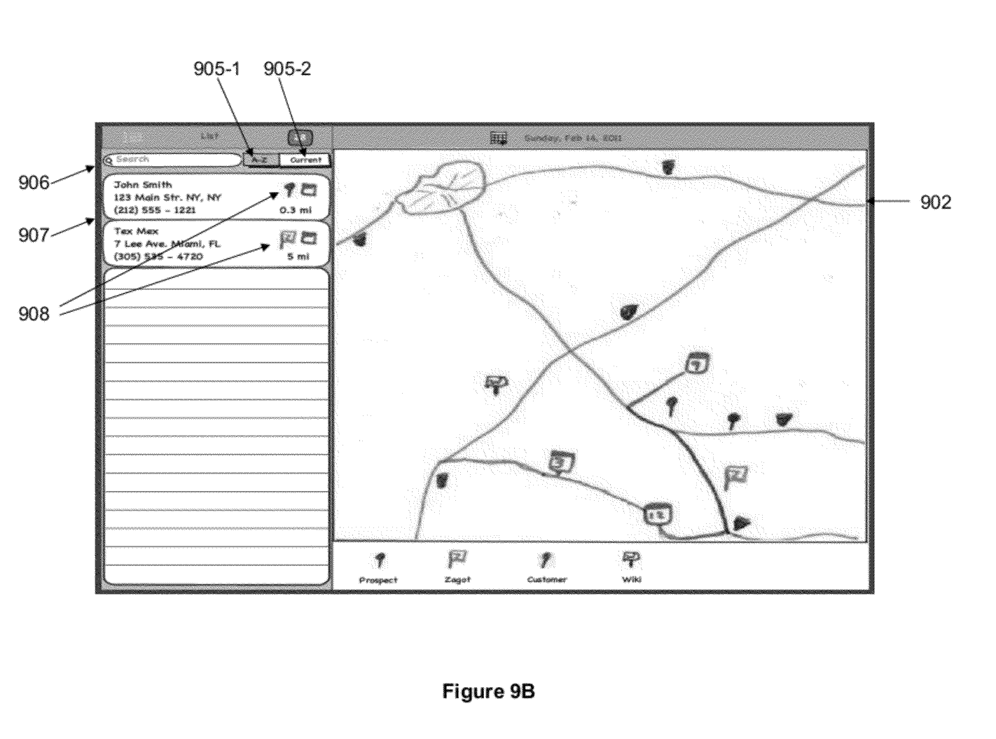

FIGS. 9A and 9B show a calendar visualization app in accordance with these embodiments. FIG. 9A shows directories 901-1 through 901-4, which can be mapped. It also shows that the user may have a set of preferences 903 to control what and how the information is displayed on a map. In one embodiment, the app can show POIs (or appointments) associated only with a particular directory. For example, the user can select one or more directories or databases, in which case the app would only show POIs associated with at least one of the selected directories or databases. Additionally, it shows that the user can assign a default meeting duration time 904 to facilitate entry of an appointment. Other possible features can also be added without departing from the spirit of the disclosed subject matter. For example, default meeting durations could be associated with specific entries.

FIG. 9B shows directories 901-1 through 901-4 mapped on map 902. FIG. 9B also shows that appointment entries from multiple directories can be shown as a single unified list 907 on the left, where an indicator (pin image) 908 shows the directory to which the entry is a member. It also shows that this aggregated list can be sorted in alphabetic order 905-1 or based on distance from a relative point on a map. In the example shown, the relative point is the current location 905-2. Likewise the search function 906 can search multiple directories.

In some embodiments, the indicator 908 can change its shape and/or color based on the details of the appointment. For example, if an appointment has a high priority, the indicator 908 associated with that appointment would be a large flag. On the other hand, if an appointment has a high priority, the indicator 908 associated with that appointment would be a small flag. The color of the flag can also depend on other details of the appointment, for instance, the time of the appointment (AM or PM) or the type of appointment (e.g., business).

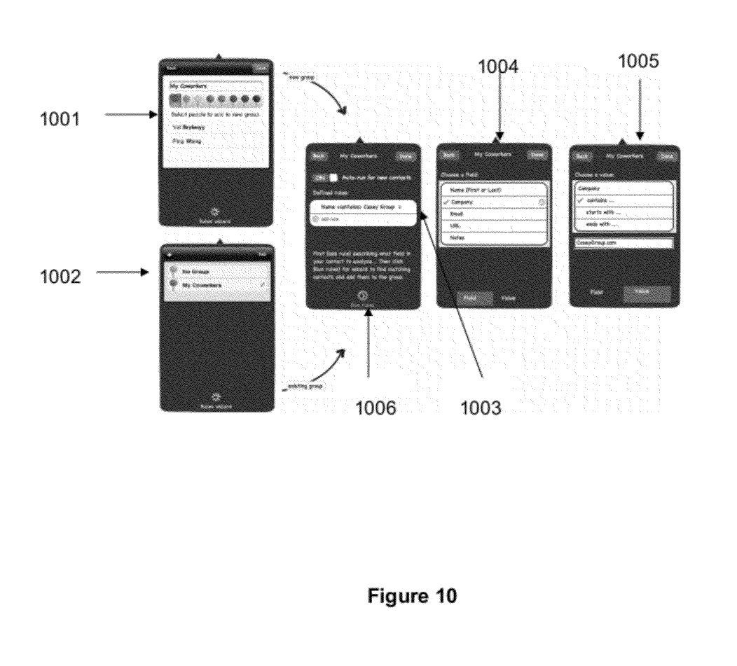

In accordance with some embodiments of the disclosed subject matter, a calendar visualization app provides for automatic grouping of contacts based on the contact information associated with the contacts and a set of user definable rules as illustrated in FIG. 10. The contact information can include a telephone number, an address, or an affiliation. The set of user definable rules can include groupings by the area code of telephone numbers, the county associated with the address, or by affiliations. In FIG. 10, rules can be configured for a new group 1001 or an existing group 1002. A rule can be added 1003 with a field 1004 and value 1005. The rule can be run 1006 to find matching contacts and add them to a group.

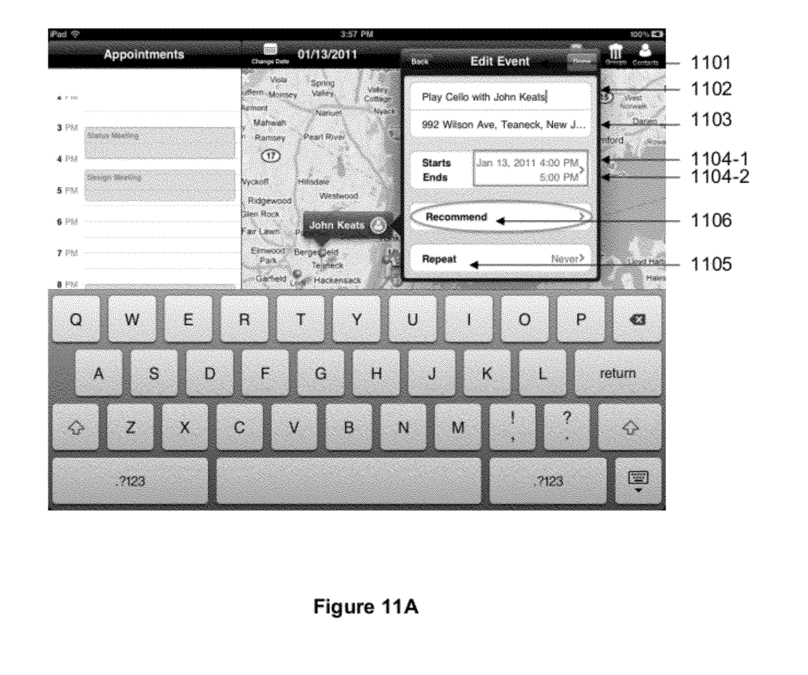

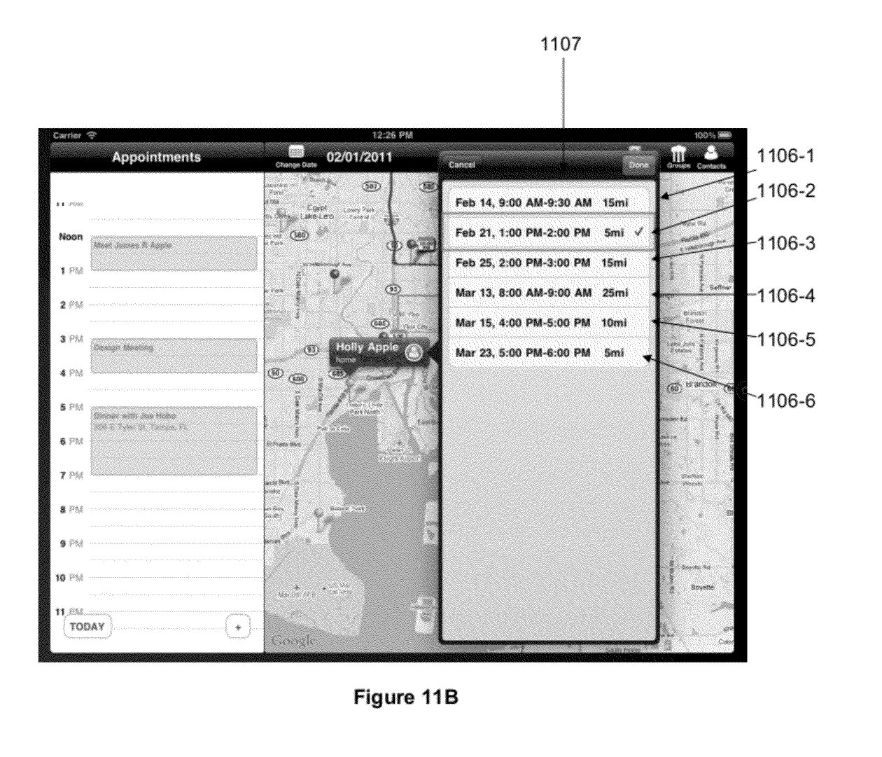

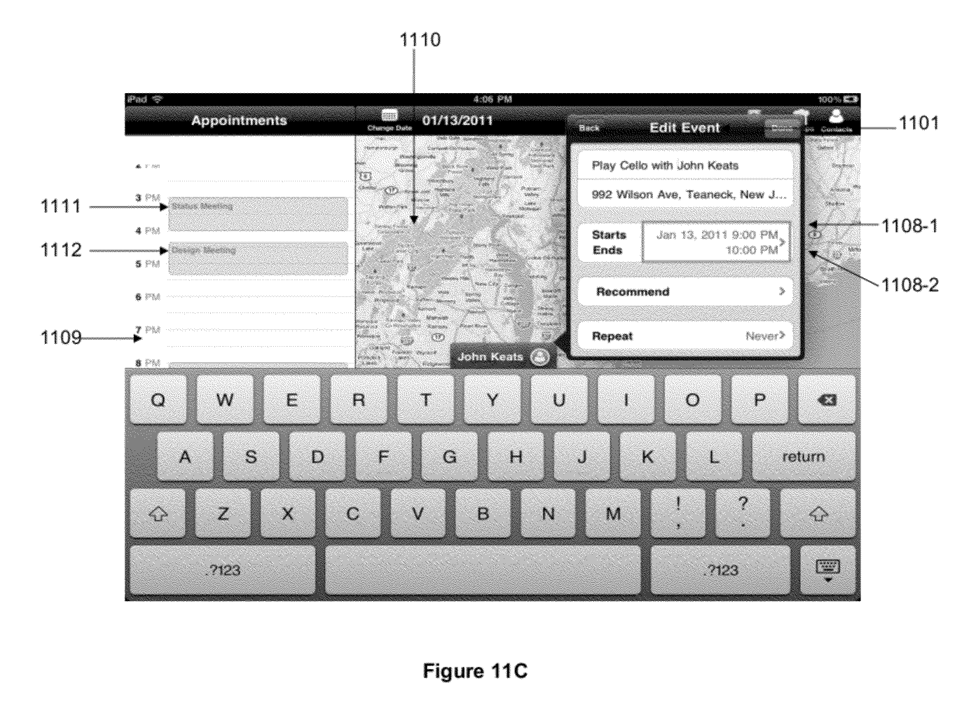

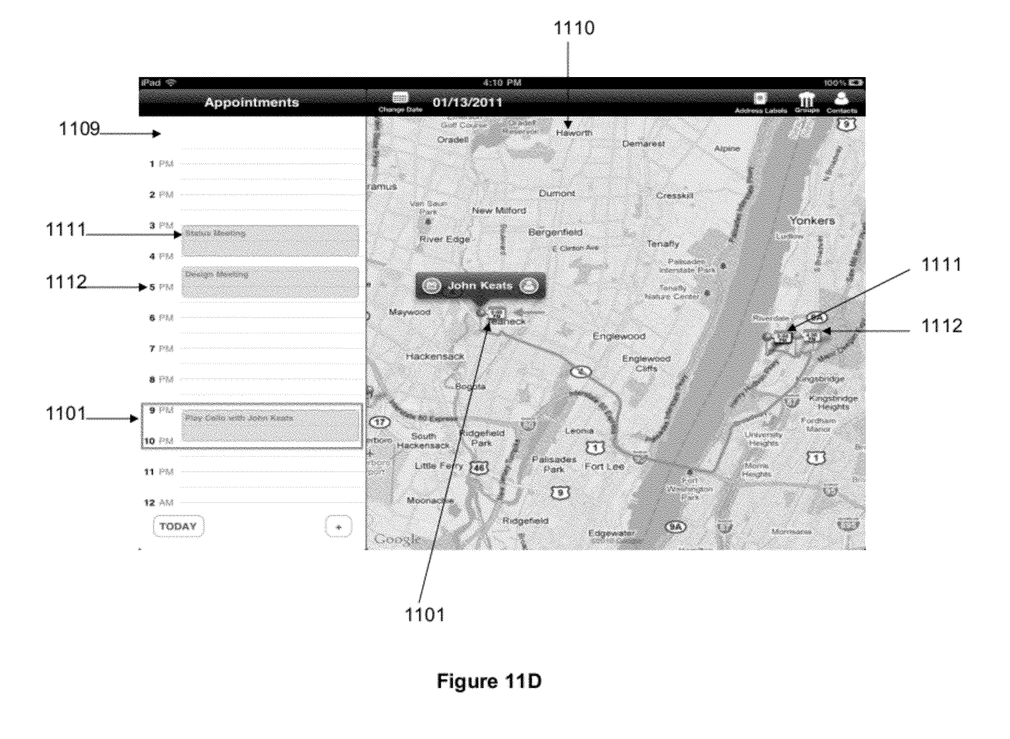

In accordance with some embodiments of the disclosed subject matter, a calendar visualization app provides a “look forward” scheduling feature, which allows it to look ahead a user definable number of weeks and to recommend appointment dates and times for a new appointment based on existing appointments. The app can recommend the time for the new appointment based on the location of the new appointment and the location of existing appointments, or the desired time for the new appointment based on the scheduled time of the existing appointments. For example, the look forward feature can find an existing appointment that is geographically close to the location of the new appointment, and recommend an empty time slot around that existing appointment for the new appointment. The geographical proximity between the new appointment and an existing appointment can be based on the sum of squared difference between the latitude/longitude of the two appointments. If many existing appointments are close to the geographic location of the new appointment, the app can recommend an empty time slot around the earliest one of those existing appointments, or recommend one or more empty time slots around one or more of those existing appointments. It can then display a list of recommended appointment dates and times in order based on shortest distance as compared to existing future appointments. FIGS. 11A through 11D illustrate a calendar visualization app in accordance with these embodiments of the disclosed subject matter.

FIG. 11A shows an appointment 1101 with a name 1102, location 1103, start time 1104-1, end time 1104-2, and repeat frequency 1105. The calendar visualization app provides a Recommend option 1106 where a user can select the “look forward” scheduling feature.

FIG. 11B shows that the “look forward” scheduling feature can look ahead a user definable number of weeks and recommend appointment dates and times 1106-1 through 1106-6 based on closeness (distance) of existing appointments as compared to the appointment being set up. It can then display a list of recommended appointment dates and times 1107 in order based on shortest distance or earliest date as compared to existing future appointments. FIG. 11B presents the list 1107 in order by earliest date and also shows the distance. The distance is a function of the location associated with the appointment being added as compared the location of future appointments.

FIGS. 11C and 11D show the appointment 1101 with a start and end time 1108-1 and 1108-2, respectively. The appointment 1101 is shown under the appointment list 1109 and it is mapped on the map 1110, along with other appointments 1111 and 1112.

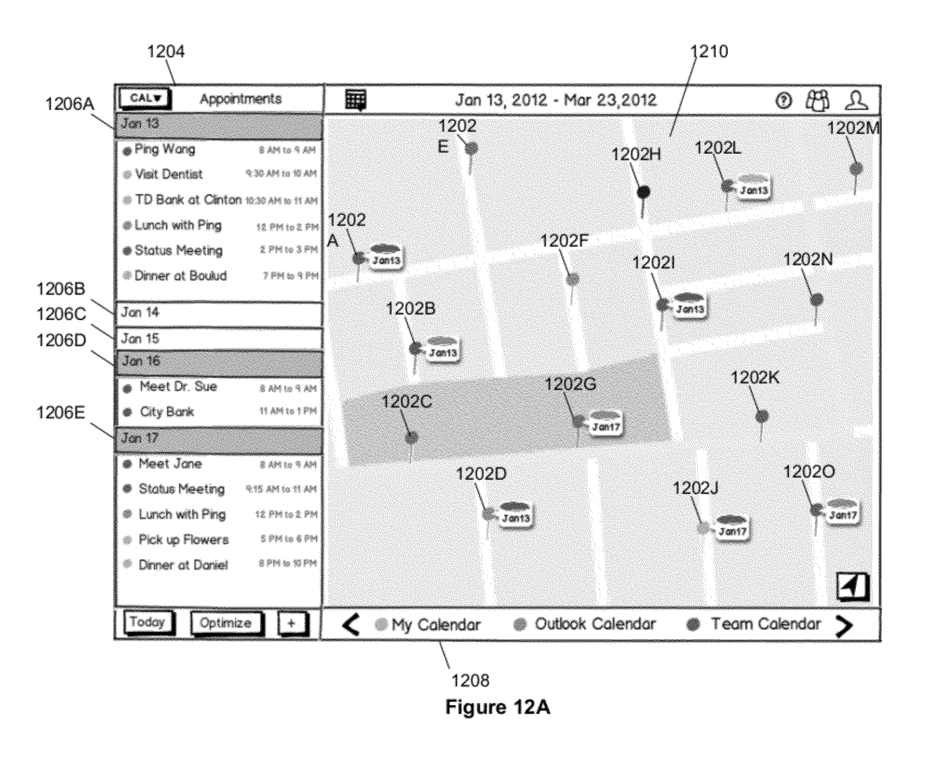

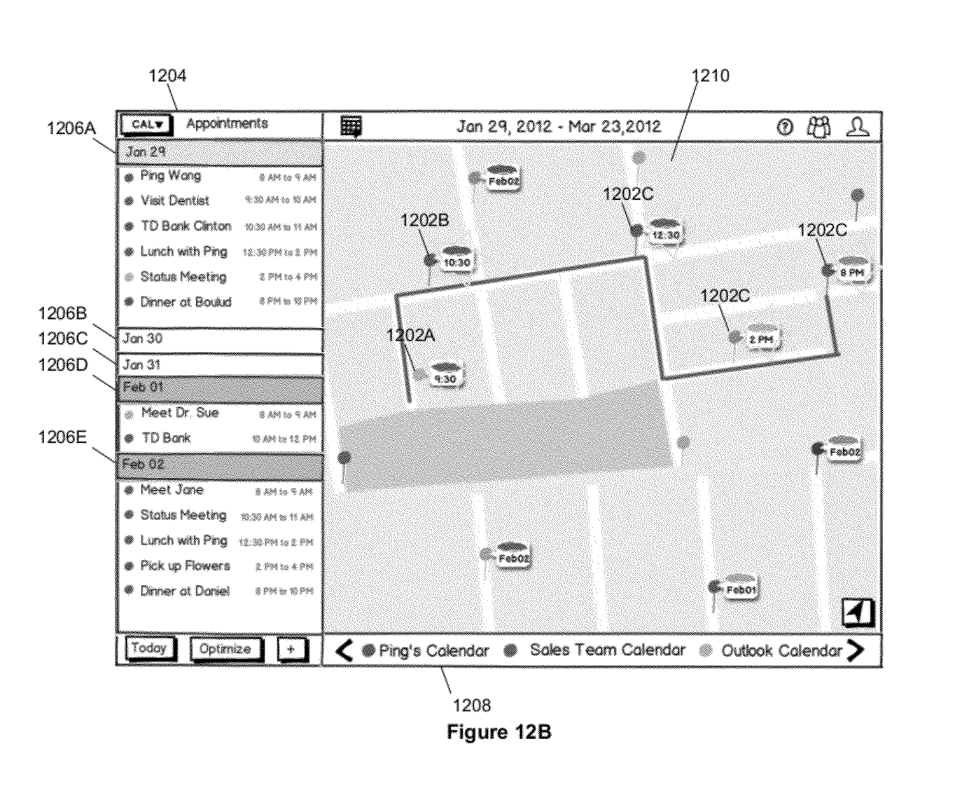

In accordance with some embodiments of the disclosed subject matter, a calendar visualization app provides an interface to view scheduled appointments from multiple calendars as illustrated in FIGS. 12A-12B. For example, FIG. 12A shows a set of appointments on a map 1210 for a range of dates selected by the user. The appointment flags 1202A-1202O can convey at least three items of information: the location of the appointment, the date of the appointment, and the calendar to which the appointment belongs. An appointment listings 1206A-1206E for the specified date range, grouped by day, can be depicted to the left of the screen. The listing 1204 has several distinguishing features. For example, appointments in the listing 1204 are separated by bars 1206A-1206E, showing the Date, referred to as a “day bar”. When the day bar 1206 is tapped, the app will highlight, in the listing 1204, the appointments associated with that day and show, on the map 1210, the routes for that day, as illustrated in FIG. 12B in accordance with certain embodiments. When the day bar 1206 is tapped again, the app will undo these operations and return to a screen illustrated in FIG. 12A. When the day bar 1206 is double-tapped, the app will switch to a single day appointment view and show the appointments for the selected day.

FIGS. 12A and 12B also show a scrollable view 1208 below the map 1210, which denotes the various calendars selected by the user for viewing. The round colored circle in this view corresponds to the color assigned by the user to distinguish their various calendars. The color assigned to a calendar can also used to denote to which calendar an appointment belongs. For example, in the appointment listing 1204, an appointment is accompanied by a colored circle to denote which calendar the appointment belongs to. Likewise, in the map 1210, an appointment flag corresponding to an appointment uses the color of the associated calendar.

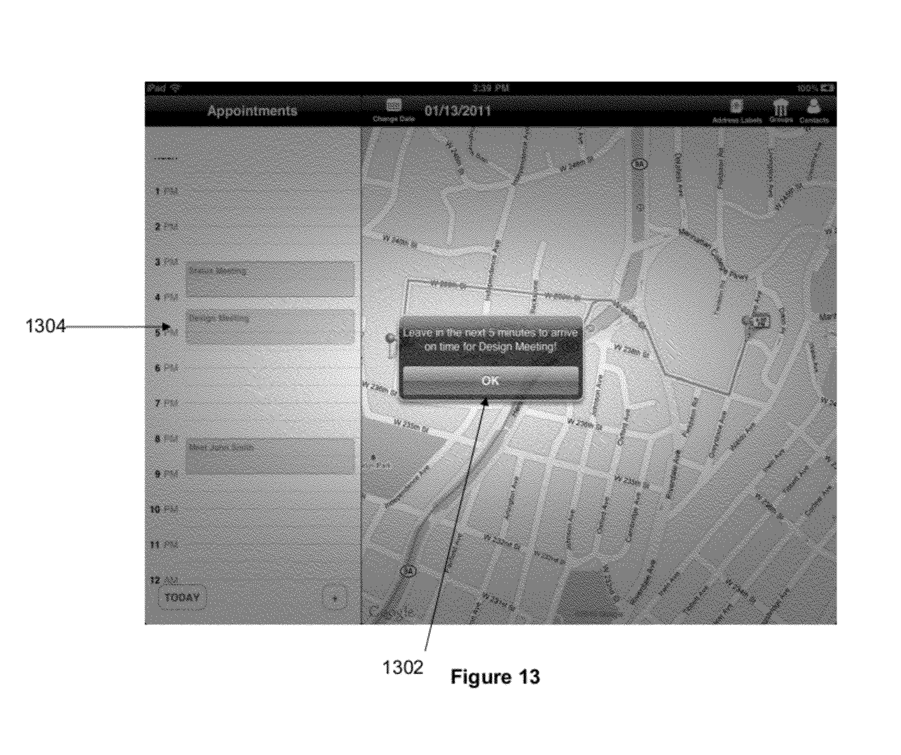

In accordance with some embodiments of the disclosed subject matter, a calendar visualization app provides for a dynamic alert function for location-identified appointments. The app can calculate the time needed to get to one's next appointment based on a dynamic determination of one's current location. It may also allow a user to add a user definable time buffer. It can then subtract this result from the current time to yield the time to trigger an alert for the user. It can alert the user that there is not enough time to make a next appointment in real time based on the user's current location. FIG. 13 shows an example where alert 1302 is triggered based on the estimated travel time to a next appointment 1304 based on a current location.

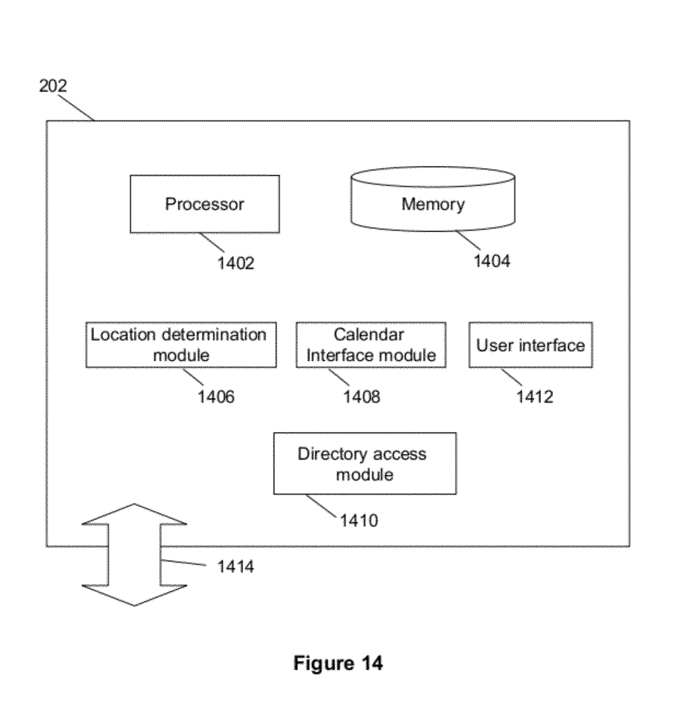

FIG. 14 illustrates a logical view of a computing device running the calendar visualization app in accordance with some embodiments of the disclosed subject matter. The computing device 202 includes a processor 1402, a memory 1404, a location determination module 1406, a calendar interface module 1408, a directory access module 1410, a user interface 1412, and a communication interface 1414.

The computing device 202 can be a universal mobile telecommunication system (UMTS), a long term evolution (LTE) user equipment, or other equipment that offers communication over wireless networks. The computing device 202 can communicate with one or more radio access networks and with wired communication networks. The computing device 202 can be a cellular phone having phonetic communication capabilities. The computing device 202 can also be a smart phone providing services such as word processing, web browsing, gaming, e-book capabilities, an operating system, and a full keyboard. The computing device 202 can also be a tablet computer providing network access and most of the services provided by a smart phone such as an Apple iPad, RIM Playbook, SAMSUNG GALAXY TAB, and HTC EVO. The screen can be a touch screen that is used to input data to the mobile device, in which case the screen can be used instead of the full keyboard. The computing device 202 can also keep global positioning coordinates, profile information, or other location information.

The location determination module 1406 can determine the location of the computing device 202. The location determination module 1406 can receive its location information from a base station coupled to the network provider, such as a cell phone network provider or a Wi-Fi network provider. The location determination module 1406 can also include a global positioning system (GPS) sensor that can detect the geographical coordinate of the computing device 202.

The calendar interface module 1408 can render the interface of the calendar visualization app to the users. The calendar visualization app's interface can include the map and the appointment listings, for example as illustrated in FIGS. 1, 4, 8, 9, 11-13. The map and the appointment listings can provide a simple way to input and retrieve the appointments, as disclosed in one or more disclosed embodiments.

A directory access module 1410 can access directories and retrieve information about locations. The directory access module 1410 can also cause the display of the computing device to display information associated with locations.

The calendar interface module 1408 and the directory access module 1410 can be implemented in software, which may be stored in memory 1404. The memory 1404 can be a computer readable medium, a programmable read only memory (PROM), electrically erasable programmable read only memory (“EEPROM”), flash memory or other similar types of memory. The software runs on a processor 1402 capable of executing computer instructions or computer code. The client module might also be implemented in hardware using an application specific integrated circuit (ASIC), programmable logic array (PLA), field programmable gate array (FPGA), or any other integrated circuit.

The user interface 1412 can include a display that receives the calendar visualization app's interface from the calendar interface module 1408 and provides it to the user. The user interface 1412 can also include a keyboard. The keyboard can be an on-screen keyboard displayed on the display or a stand-alone keyboard as previously described.

The communication interface 1414 provides an input and/or output mechanism to communicate over a network. The communication interface 1414 enables communication with servers 204, as well as other core network nodes to send and receive data. The communication interface 1414 is implemented in hardware to send and receive signals in a variety of mediums, such as optical, copper, and wireless, and in a number of different protocols, including cellular network protocols including UMTS, HSPA, HSPA+, LTE, and LTE advanced, some of which may be non-transient.

In accordance with some embodiment of the disclosed subject matter, a calendar visualization app provides integration with one or more of the following: iPad Address Book, Calendar, Google Maps, and Bing Maps. In some embodiments of the disclosed subject matter, a calendar visualization app provides Microsoft Exchange support.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

The systems and methods for visualizing calendar appointments on map are not limited in its application to the details of process and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting. Moreover, certain features which are well known in the art are not described in detail in order to avoid obscuring the description of the disclosed subject matter.

In some embodiments of the disclosed subject matter, the software needed for implementing a process or a database includes a high level procedural or an object-orientated language such as C, C++, C#, Java, Python, or Perl. The software may also be implemented in assembly language if desired. The language can be a compiled or an interpreted language. Packet processing implemented in a server includes any processing determined by the context. For example, packet processing may involve high-level data link control (HDLC) framing, header compression, and/or encryption. In some embodiments of the disclosed subject matter, the software is stored on a storage medium or device such as read-only memory (ROM), programmable-read-only memory (PROM), electrically erasable programmable-read-only memory (EEPROM), flash memory, or a magnetic disk that is readable by a general or special purpose-processing unit to perform the processes described in this document. The processors can include any microprocessor (single or multiple core), system on chip (SoC), microcontroller, digital signal processor (DSP), graphics processing unit (GPU), or any other integrated circuit capable of processing instructions such as an x86 microprocessor.

As such, those skilled in the art will appreciate that the conception, upon which this disclosure is based, may readily be utilized as a basis for the designing of other methods and systems for carrying out the several purposes of the present disclosed subject matter. It is important, therefore, that the disclosed subject matter be regarded as including equivalent process to those described herein insofar as they do not depart from the spirit and scope of the present disclosed subject matter.

For example, the specific sequence of the described process may be altered so that certain processes are conducted in parallel or independently, with other processes, to the extent that the processes are not dependent upon each other. Thus, the specific order of steps and/or functions described herein is not to be considered implying a specific sequence of steps to perform the process. Other alterations or modifications of the above processes are also contemplated.

In addition, features illustrated or described as part of one embodiment can be used on other embodiments to yield a still further embodiment. Additionally, certain features may be interchanged with similar devices or features not mentioned yet which perform the same or similar functions. It is therefore intended that such modifications and variations are included within the totality of the present disclosure.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Features of the disclosed embodiments can be combined and rearranged in various ways within the scope and spirit of the disclosure. Other uses of the disclosed embodiments are within the following claims. For example, the disclosed embodiments can be used to schedule events in addition to scheduling appointments. A user can identify interesting events, and the disclosed embodiments can, in turn, provide a schedule of the interesting events to the user.

We claim:

1. A data processing apparatus comprising:
a display;
one or more interfaces configured to provide communication with a server; and
a processor, in communication with the one or more interfaces, and configured to run a module stored in memory that is configured to obtain event information associated with a plurality of events, wherein the event information includes a start time for one of the plurality of events, to obtain travel routes between at least two consecutive events, and to instruct the display to display the travel routes between the at least two consecutive events on a map.

2. The data processing apparatus of claim 1, wherein the event information includes a location identifier associated with at least one of the plurality of events.

3. The data processing apparatus of claim 1, wherein the module is further configured to obtain an estimated travel time between the at least two consecutive events, and to instruct the display to display the travel routes using a predetermined color, wherein the predetermined color depends on the estimated travel time and an amount of time between the at least two consecutive events.

4. The data processing apparatus of claim 1, wherein the module is configured to send a schedule request to the server, the schedule request including the event information associated with the plurality of events, and to receive a schedule response from the server, the schedule response including a start time and an end time of each one of the plurality of events, the travel routes between at least two consecutive events, and an estimated travel time between the at least two consecutive events.

5. The data processing apparatus of claim 4, wherein the event information includes a predetermined start time of the one of the plurality of events.

6. The data processing apparatus of claim 4, wherein the event information includes a range of time in which the one of the plurality of events should be scheduled.

7. The data processing apparatus of claim 4, wherein the event information includes a route determination policy, the route determination policy including at least one of reducing a travel distance between consecutive events, reducing an estimated travel time between consecutive events, or reducing both a travel distance and an estimated travel time between consecutive events.

8. The data processing apparatus of claim 1, wherein the module is configured to determine a current time and a starting time of a next event, to obtain an estimated travel time from a current location to a location of the next event, and to instruct the display to indicate that an amount of time between the current time and the starting time of the next event is less than the estimated travel time.

9. The data processing apparatus of claim 1, wherein the module is further configured to receive event information of an additional event, the event information of the additional event including a location identifier associated with the additional event, to select one of the plurality of events based on the location identifier, and to recommend a time for the additional event based on the one of the plurality of events.

10. The data processing apparatus of claim 1, wherein one of the plurality of events includes an appointment.

11. A method comprising:
receiving event information associated with a plurality of events;
obtaining a schedule of the plurality of events, wherein the schedule is based on the event information associated with the plurality of events;
obtaining travel routes between at least two consecutive events; and
displaying the travel routes on a map.

12. The method of claim 11, further comprising:
obtaining an estimated travel time between the at least two consecutive events; and
displaying the travel routes using a predetermined color that depends on the estimated travel time and an amount of time between the at least two consecutive events.

13. The method of claim 11, further comprising:
determining a current time;
determining a starting time of a next event in the schedule;
obtaining an estimated travel time from a current location to a location of the next event; and
displaying an indication that an amount of time between the current time and the starting time of the next event is less than the estimated travel time.

14. The method of claim 11, further comprising:
receiving event information of an additional event, the event information including a location identifier of the additional event,
selecting one of the plurality of events based on the location identifier; and
recommending a time for the additional event based on the one of the plurality of events.

15. An apparatus comprising:
one or more interfaces configured to provide communication with a computing device; and
a processor, in communication with the one or more interfaces, and configured to run a module stored in memory that is configured to receive a schedule request from the computing device, the schedule request including event information associated with a plurality of events, the event information including a start time and an end time for a schedule of the plurality of events, to obtain distance information between at least one pair of the plurality of events, to determine the schedule of the plurality of events based on the distance information, and the start time and the end time for the schedule, and to provide a schedule response to the computing device, the schedule response including the schedule of the plurality of events.

16. The apparatus of claim 15, wherein the module is further configured to obtain an estimated travel time between at least one pair of the plurality of events, and to provide the estimated travel time in the schedule response.

17. The apparatus of claim 16, wherein the module is further configured to receive the distance information from a map server, and to receive the estimated travel time from the map server.

18. The apparatus of claim 15, wherein the event information includes a predetermined start time of one of the plurality of events.

19. The apparatus of claim 15, wherein the event information includes a range of time in which one of the plurality of events should be scheduled.

20. The apparatus of claim 15, wherein the event information includes a route determination policy for the schedule of the plurality of events, the route determination policy including at least one of reducing a travel distance between consecutive events, reducing an estimated travel time between consecutive events, or reducing both a travel distance and an estimated travel time between consecutive events.

21. A data processing apparatus comprising:
a display; and
a processor configured to run a module stored in memory that is configured to obtain location information of a first point of interest (POI), to obtain tag information associated with the first POI from a directory, to instruct the display to display the first POI on a map, and to instruct the display to display a portion of the tag information associated with the first POI, wherein the portion of the tag information is determined based on the directory.

22. The data processing apparatus of claim 21, wherein the directory includes an address book.

23. The data processing apparatus of claim 21, wherein the module is further configured to receive a selection of the directory, and to instruct the display to display the first POI on the map in response to the selection of the directory.

24. The data processing apparatus of claim 21, wherein the module is further configured to include the first POI in a list of POIs of an itinerary in response to a selection of the first POI, and further configured to obtain a schedule for the itinerary.

25. The data processing apparatus of claim 21, wherein, in response to a selection of the first POI, the module is further configured to provide an interface to create an appointment at the first POI, and to instruct the display to display appointment information associated with the appointment.

26. The data processing apparatus of claim 21, wherein the module is further configured to obtain location information of a second point of interest (POI), wherein the first POI associated with a first group and the second POI associated with a second group, and wherein the module is further configured to instruct the display to display the first POI in response to a selection of the first group, and to instruct the display to display the second POI in response to a selection of the second group.

27. The data processing apparatus of claim 26, wherein the module is further configured to identify that the first POI is associated with the first group based on a portion of the tag information associated with the first POI.

28. The data processing apparatus of claim 26, wherein the module is further configured to receive an input from a user that the first POI is associated with the first group and the second POI is associated with the second group.

29. The data processing apparatus of claim 26, wherein the module is further configured to obtain a travel route between the first POI and the second POI and to display the travel route on the map.

30. The data processing apparatus of claim 26, wherein the module is further configured to obtain tag information associated with the second POI from another directory, and to instruct the display to display a portion of the tag information associated with the second POI.
